(19) United States
(12) Patent Application Publication
(10) Pub. No.: US 2015/0198726 A1
(43) Pub. Date: Jul. 16, 2015

(54) Imbedded Mobile Detection Device

(71) Applicant: Mitch M. C. Chou, Kaohsiung City (TW)

(72) Inventors: Mitch M. C. Chou, Kaohsiung City (TW); Chu-An Li, Kaohsiung City (TW)

(21) Appl. No.: 14/578,750

(22) Filed: Dec. 22, 2014

(30) Foreign Application Priority Data
Jan. 10, 2014 (TW) 103101104

(51) Int. Cl. G01T 1/36; G01T 1/202; G01T 1/20

(52) U.S. Cl. CPC G01T 1/362; G01T 1/2018; G01T 1/2023

(57) ABSTRACT

An imbedded mobile detection device includes a radiation detector, comprising a detection crystal and a photo-sensitive element, a radiation detector, an analog-digital converter (ADC), and a software application unit, wherein the detection crystal is a C:Al₂O₃ crystal having oxygen vacancy deficiencies formed by subjecting a carbon covered Al₂O₃ structure to vacuum diffusion and atmosphere annealing, when any radioactive particle exists in an on-spot environment, an energy thereof is absorbed through a recombination process of the vacancy deficiencies. Finally, the radiation energy spectrum analysis information is obtained through a measurement, by which some environmental radiations and waste containing radioactive material emitted from some radiation plants may be measured and analyzed, achieving the efficacy of an online measurement result processing and providing an accurate nuclide determination.

### FIELD OF THE INVENTION

The present invention relates to an imbedded mobile detection device, and particularly to such device based on a C:Al₂O₃ crystal having oxygen vacancy deficiencies. More particularly, the present invention relates to such a device which is able to immediately measure and analyze some environmental radiations and waste containing radioactive material emitted from some radiation plants, achieving an online measurement result processing and providing an accurate nuclide determination.

### DESCRIPTION OF THE RELATED ART

Several common detection means have been provided for various radiation and detection purposes, including a clerk film badge, a radiation dose pen or watch, a portable radiation detector, a pollution detector, an environmental monitor, and the like.

As an example, the serious radiation leakage resulted from damage of the nuclear power plant in Japan owing to the tsunami some years ago, the leak radiation particles are all invisible α, β, and γ particles. Such invisible particles are not only hard to be seen, but also impose a danger to human lives when the particle films are large up to some extent.

To detect the radiation particles of the invisible light, the above mentioned exclusive detector instrument portable radiation detector, pollution detector, and the environmental detector. However, such instrument is not small in volume and inconvenient to be carried at hand, its cost is also expensive, such as for the Geiger counter.

For this, the above mentioned film badge, radiation dose pen or watch, which has its principle as an application of film photo-sensitivity may be worn on chest or hand. Although its use is convenient, it has to be collected to be examined by a professional after a period of time of use. In examination, the professional first develop and then fix the film. By obtaining a sensitivity value, the radiation dose may be determined. By means of this examination manner, steps of the examination are complicated and time consuming, and the measure result may not be obtained soon. Therefore, one my not know if the environment has a radiation amount beyond a safety standard he/she is located. Namely, the effect of this examination method is merely limited an after-event recordation.

Therefore, the conventional means may not satisfy the user's need with online providing the information regarding if the environment the user is located has a radiation amount beyond a safety value.

### SUMMARY OF THE INVENTION

It is, therefore, an object of the present invention to provide an imbedded mobile detection device which is able to immediately measure and analyze some environmental radiations and waste containing radioactive material emitted from some radiation plants, achieving an online measurement result processing and providing an accurate nuclide determination.

According to the present invention, the imbedded mobile detection device comprises a radiation detector, comprising a detection crystal and a photo-sensitive element, for effectively absorbing a species and an energy range of radioactive particles of a predetermined detection object, and generating an analog pulse signal based thereon, wherein the detection crystal is a C:Al₂O₃ crystal having oxygen vacancy deficiencies formed by subjecting a carbon covered Al₂O₃ structure to vacuum diffusion and atmosphere annealing, when any radioactive particle exists in an on-spot environment, an energy thereof is absorbed through a recombination process of the vacancy deficiencies, and the photo-sensitive element converts photo-pulses generated by the detection crystal having absorbed the energy of the radioactive particles into an analog pulse signal; an analog-digital converter (ADC), coupled to the radiation detector and converting the analog pulse signal into a digital logic pulse signal; and a software application unit, coupled to the ADC and receiving and computing the digital logic pulse signal by using a software setting function thereof, executing a radiation energy spectrum calculation and a nuclide comparison program, acquiring a radiation energy spectrum analysis information, so that a measurement result is online processed and a species of the nuclide is accurately determined.

In an embodiment, the radioactive particles are α-particles, β-particles, or γ-particles.

In an embodiment, the photo-sensitive element is one of a photodiode and a photomultiplier.

In an embodiment, when the on-spot environment has the radioactive particles, in the detection crystal electrons at a valence band (VB) jump onto a conduction band, the electrons are trapped at a defect band (DB) having a lower energy level E1, the trapped electrons at the DB is excited to a conduction band by activating a long wavelength light source, the excited electrons releases an energy thereof onto an energy level E2 lower than the DB, so that the energy of the radioactive particles has an absorption through a deficiency recombination process.

In an embodiment, the energy level E1 is greater than the energy level E2.

In an embodiment, the shorter wavelength light source includes a green light emitting diode (LED), a blue LED, and a violet LED.

In an embodiment, the software application unit has a plurality of software setting functions including calculation, recordation, display, and data transmission for measuring a pulse width count of the digital logic pulse signal to produce an energy count information as the pulse width measurement result, by which the radiation energy spectrum calculation and the nuclide comparison program including a nuclide species identification and an activeness computation are executed according to a user's command, and finally a background noise is filtered out to obtain the radiation energy spectrum analysis information.

In an embodiment, the imbedded mobile detection device includes a smart mobile phone, a digital camera, a digital video-recorder, a portable multi-media play, a portable navigation device, a personal digital assistant (PDA), a digital photo frame, and a mobile networking device.

### BRIEF DESCRIPTIONS OF THE DRAWINGS

The present invention will be better understood from the following detailed descriptions of the preferred embodiments according to the present invention, taken in conjunction with the accompanying drawings, in which:

FIG. 1 is a schematic diagram of an imbedded mobile detection device according to the present invention; and

FIG. 2 is a schematic diagram of a deficiency recombination mechanism of a detection crystal according to the present invention.

### DESCRIPTION OF THE PREFERRED EMBODIMENTS

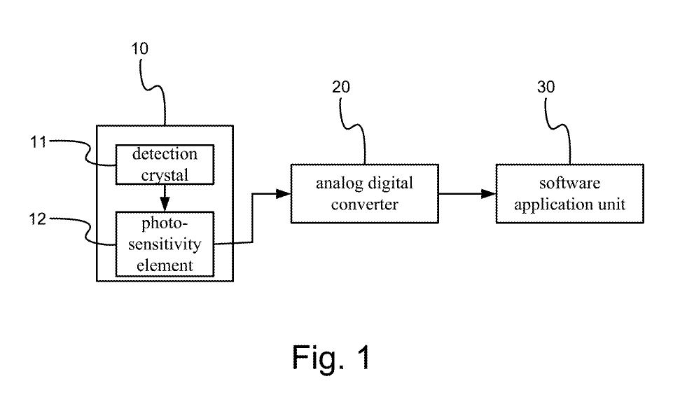

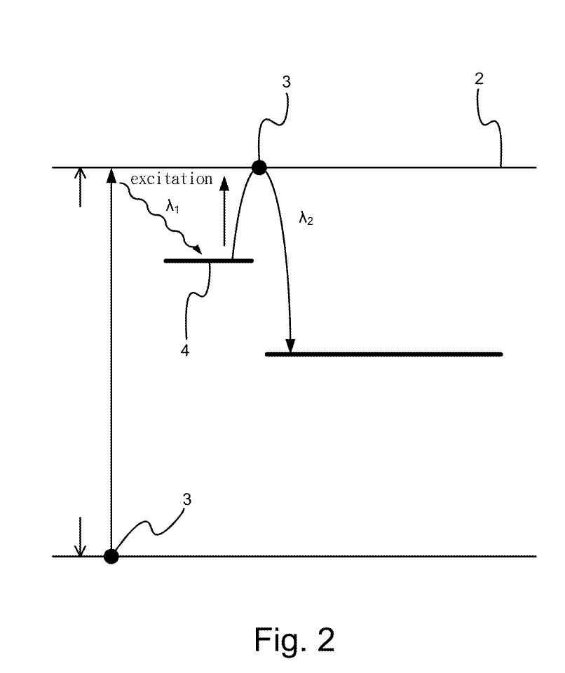

Referring to FIG. 1 and FIG. 2, which are a schematic diagram of an imbedded mobile detection device according to the present invention, and FIG. 2 is a schematic diagram of a deficiency recombination mechanism of a detection crystal according to the present invention. As shown, the present invention is an imbedded mobile detection device, such as a smart mobile phone, a digital camera, a digital video-recorder, a portable multi-media play, a portable navigation device, a personal digital assistant (PDA), a digital photo frame, and a mobile networking device.

The imbedded mobile detection device 10 comprises a radiation detector 10, an analog-digital converter (ADC) 20, and a software application unit 30.

The radiation detector 10 comprises a detection crystal 11 and a photo-sensitive element 12, and is used for effectively absorbing a species and an energy range of radioactive particles of a predetermined detection object, by which an analog pulse signal may be generated based thereon, wherein the detection crystal is a C:Al₂O₃ crystal having oxygen vacancy deficiencies formed by subjecting a carbon covered Al₂O₃ structure to vacuum diffusion and atmosphere annealing. When any radioactive particle exists in an on-spot environment, an energy thereof is absorbed through a recombination process of the vacancy deficiencies, and the photo-sensitive element converts photo-pulses generated by the detection crystal having absorbed the energy of the radioactive particles into an analog pulse signal. The photo-sensitive element 12 may be a photodiode or a photomultiplier, which converts the photo pulses generated from absorption of the radioactive particles energy in the analog pulse signal.

The ADC 20 is coupled to the radiation detector 10 and converts the analog pulse signal into a digital logic pulse signal.

The software application unit 30 is coupled to the ADC 20 and used for receiving and computing the digital logic pulse signal by using a software setting function thereof. Further, the software application unit executes a radiation energy spectrum calculation and a nuclide comparison program, acquiring a radiation energy spectrum analysis information, so that a measurement result is online processed and a species of the nuclide is accurately determined.

As such, a novel imbedded mobile detection device is composed as the above described.

In an embodiment, the imbedded mobile detection device includes a smart mobile phone, a digital camera, a digital video-recorder, a portable multi-media play, a portable navigation device, a personal digital assistant (PDA), a digital photo frame, and a mobile networking device. As shown in FIG. 2, when the on-spot environment has α, β, and γ radioactive particles, electrons 3 at a valence band (VB) in the detection crystal 11 will jump to a conduction band (CB) 2. The electrons are trapped at a defect band (DB) 4 having a lower energy level E1. And, the trapped electrons at the DB 4 is excited to a conduction band by activating a long wavelength light source. Then, the excited electrons releases its energy onto an energy level E2 lower than that of the DB 4, so that the energy of the radioactive particles has an absorption through a deficiency recombination process. In the above, the energy level E1 is larger than the energy level E2, and this energy gap may have a long wavelength light emitted. Thereafter, the photo-sensitive element 12 converts photo-pulses generated by the detection crystal 11 having absorbed the energy of the radioactive particles into an analog pulse signal. Then, the ADC 20 converts the analog pulse signal into a digital logic pulse signal.

Finally, a software application unit 30 is provided to measure a pulse count to form an energy count information as the pulse width. The software application unit 30 has a software setting function, such as a mathematical calculation, recordation, display, and data transmission functions.

Further, the software application unit 30 executes a radiation energy spectrum calculation and a nuclide comparison program including a nuclide species identification and an activeness computation are executed according to a user's command. The software application unit 30 acquires a radiation energy spectrum analysis information, so that a measurement result is online processed and a species of the nuclide is accurately determined. As such, some environmental radiations and waste containing radioactive material emitted from some radiation plants may be measured and analyzed, achieving the efficacy of an online measurement result processing and providing an accurate nuclide determination.

In view of the above, the present invention is an imbedded mobile detection device, which may effectively improve the disadvantage encountered in the prior art, comprise a detection detector including a detection crystal and a photo-sensitivity element, an ADC, and a software application unit and may be a smart mobile phone, a digital camera, a digital video-recorder, a portable multi-media play, a portable navigation device, a personal digital assistant (PDA), a digital photo frame, and a mobile networking device.

As such, some environmental radiations and waste containing radioactive material emitted from some radiation plants may be measured and analyzed, achieving the efficacy of an online measurement result processing and providing an accurate nuclide determination.

From all these views, the present invention may be deemed as being more effective, practical, useful for the consumer's demand, and thus may meet with the requirements for a patent.

The above described is merely examples and preferred embodiments of the present invention, and not exemplified to intend to limit the present invention. Any modifications and changes without departing from the scope of the spirit of the present invention are deemed as within the scope of the present invention. The scope of the present invention is to be interpreted with the scope as defined in the claims.

What is claimed is:

1. An imbedded mobile detection device, comprising:
a radiation detector, comprising a detection crystal and a photo-sensitive element, for effectively absorbing a species and an energy range of radioactive particles of a predetermined detection object, and generating an analog pulse signal based thereon, wherein the detection crystal is a C:Al₂O₃ crystal having oxygen vacancy deficiencies formed by subjecting a carbon covered Al₂O₃ structure to vacuum diffusion and atmosphere annealing, when any radioactive particle exists in an on-spot environment, an energy thereof is absorbed through a recombination process of the vacancy deficiencies, and the photo-sensitive element converts photo-pulses generated by the detection crystal having absorbed the energy of the radioactive particles into an analog pulse signal;
an analog-digital converter (ADC), coupled to the radiation detector and converting the analog pulse signal into a digital logic pulse signal; and
a software application unit, coupled to the ADC and receiving and computing the digital logic pulse signal by using a software setting function thereof, executing a radiation energy spectrum calculation and a nuclide comparison program, acquiring a radiation energy spectrum analysis information, so that a measurement result is online processed and a species of the nuclide is accurately determined.

2. The imbedded mobile detection device as claimed in claim 1, wherein the radioactive particles are α-particles, β-particles, or γ-particles.

3. The imbedded mobile detection device as claimed in claim 1, wherein the photo-sensitive element is one of a photodiode and a photomultiplier.

4. The imbedded mobile detection device as claimed in claim 1, wherein when the on-spot environment has the radioactive particles, in the detection crystal electrons at a valence band (VB) jump onto a conduction band, the electrons are trapped at a defect band (DB) having a lower energy level E1, the trapped electrons at the DB is excited to a conduction band by activating a long wavelength light source, the excited electrons releases an energy thereof onto an energy level E2 lower than the DB, so that the energy of the radioactive particles has an absorption through a deficiency recombination process.

5. The imbedded mobile detection device as claimed in claim 4, wherein the energy level E1 is greater than the energy level E2.

6. The imbedded mobile detection device as claimed in claim 4, wherein the shorter wavelength light source includes a green light emitting diode (LED), a blue LED, and a violet LED.

7. The imbedded mobile detection device as claimed in claim 1, wherein the software application unit has a plurality of software setting functions including calculation, recordation, display, and data transmission for measuring a pulse width count of the digital logic pulse signal to produce an energy count information as the pulse width measurement result, by which the radiation energy spectrum calculation and the nuclide comparison program including a nuclide species identification and an activeness computation are executed according to a user's command, and finally a background noise is filtered out to obtain the radiation energy spectrum analysis information.

8. The imbedded mobile detection device as claimed in claim 1, including a smart mobile phone, a digital camera, a digital video-recorder, a portable multi-media play, a portable navigation device, a personal digital assistant (PDA), a digital photo frame, and a mobile networking device.
